(19) United States
(12) Patent Application Publication
(10) Pub. No.: US 2006/0208569 A1
(43) Pub. Date: Sep. 21, 2006

(54) Airbag electronic control unit with central squib current limiting

(75) Inventor: Scott Morell, White Lake, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/368,081

(22) Filed: Mar. 3, 2006

Related U.S. Application Data
(60) Provisional application No. 60/663,518, filed on Mar. 18, 2005.

(51) Int. Cl. B60L 1/00; B60R 21/01

(52) U.S. Cl. 307/10.1; 280/735; 307/121

(57) ABSTRACT

An airbag deployment circuit includes at single current regulator controlling multiple squib deployment circuits. Squib deployment circuits that do not have to deploy simultaneously are attached to the same current regulator. A current regulation switch located prior to each current regulator is closed if any of the squib deployment circuits attached to the associated current regulator need to be deployed in a crash event. A high side transistor switch and a low side transistor switch are located adjacent each squib to control activation of that squib deployment circuit. The high side transistor switch and the low side transistor switch are also closed for each of the squib deployment circuits that are to be deployed.

The present invention claims the benefit of U.S. Provisional Patent Application No. 60/663,518, filed Mar. 18, 2005.

### BACKGROUND OF THE INVENTION

This invention relates to an electronic control unit having central current regulation for a plurality of airbag squib deployment circuits.

Electronic control units are used for deploying pyrotechnic restraint devices, such as airbags and pretensioners, during a crash event. Each airbag includes a squib deployment circuit to begin deployment of the airbag. Current regulation is provided for each squib deployment circuit to control current load to each squib deployment circuit. Thus, in known electronic control units each squib deployment circuit includes a dedicated current regulator. In a typical crash event, the electronic control unit does not deploy the entire restraint system and therefore does not ignite all of the airbag squibs. Therefore, the current regulators on the unused squib deployment circuits are not utilized. In addition it is customary to provide a safety circuit in a squib deployment circuit which has a redundant function to switch the deploy current. This is to prevent unwanted deployments due to a failure in the primary squib deployment circuit.

Accordingly, reducing the number of unused current regulators would reduce hardware and simplify circuitry, providing lower cost and increased efficiency. It is therefore desirable to develop and design an electronic control unit providing current regulation for each squib deployment circuit that reduces the amount of hardware and simplifies the electronic control unit circuitry.

### SUMMARY OF THE INVENTION

An example electronic control unit according to this invention includes an airbag deployment circuit having a multi-channel central current regulator for all squib deployment circuits.

An example electronic control unit for an airbag includes at least one airbag deployment circuit and an energy source. The energy source is utilized for multiple airbag deployment circuits such as a side curtain airbag and a side thorax airbag. Each airbag deployment circuit includes a single current regulator and multiple squib deployment circuits connected to the current regulator. In a crash event all the squib deployment circuits may not need to deploy. However, some squib deployment circuits must be simultaneously deployed. An example would be the same side of a vehicle side curtain airbags and side thorax airbags. Squib deployment circuits that are not be deployed simultaneously are attached to the same current regulator. The electronic control unit sends a signal to the airbag deployment circuit. A current regulation switch located at each channel of the current regulator closes if any of the squib deployment circuits attached to the associated current regulator need to be deployed.

These and other features of the present invention can be best understood from the following specification and drawings, the following of which is a brief description.

### BRIEF DESCRIPTION OF THE DRAWINGS

FIG. 1 is a schematic illustrate of vehicle utilizing the electronic control unit of the present invention.

FIG. 2 is schematic illustration of an electronic control unit of the present invention.

### DETAILED DESCRIPTION OF THE PREFERRED EMBODIMENT

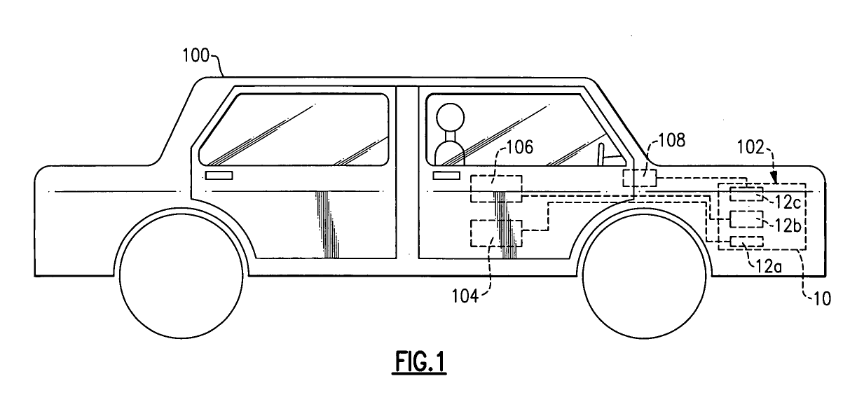

FIG. 1 illustrates a vehicle 100 having a restraint system 102. The restraint system 102 includes an electronic control unit 10 for controlling the restraint system 102. A side curtain airbag 104, a side thorax airbag 106 and a front impact airbag 108 are shown. The restraint system 102 may include other airbags and restraint (pyrotechnic) devices as is known in the art. The electronic control unit 10 includes a plurality of airbag deployment circuits 12a, 12b and 12c for each airbag, in the restraint system 102. The airbag deployment circuit 12a is associated with the side curtain airbag 104, the second airbag deployment circuit 12b is associated with the side thorax airbag 106 and the third airbag deployment circuit 12c is associated with the front impact airbag 108.

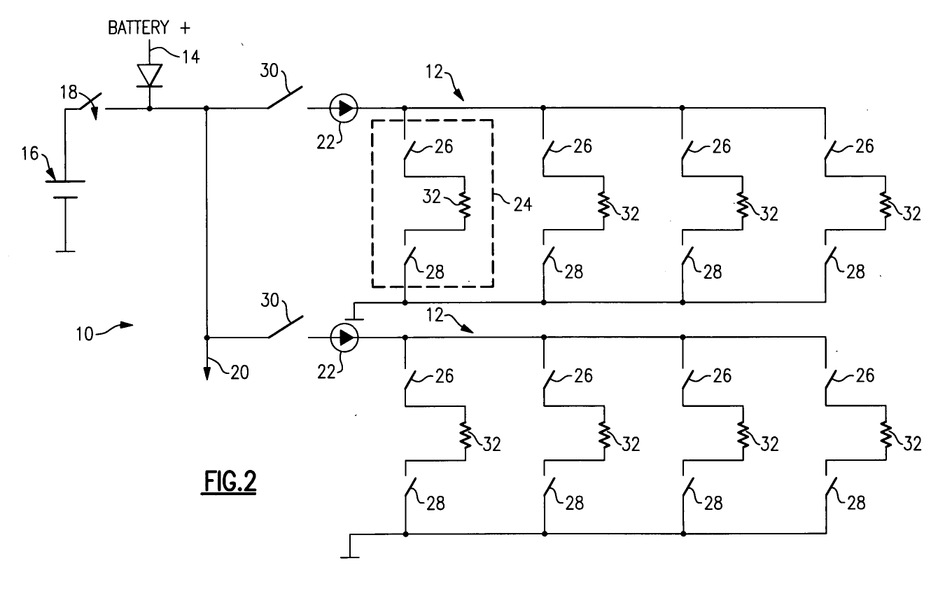

FIG. 2 illustrates the example electronic control unit 10 for the restraint system 102 according to this invention. The electronic control unit 10 includes the airbag deployment circuits 12a, 12b, 12c and an energy source 14. The energy source 14 is preferably a battery. The energy source 14 may further include an energy reserve 16. The energy reserve 16 is connected through an energy reserve switch 18. The energy reserve switch 18 is closed to complete the connection to the energy reserve 16 when the energy reserve 16 is required. The energy source 14 may be utilized in multiple airbag deployment circuits 12. For example, the airbag deployment circuit 12a for the side curtain airbag 104 and for the side thorax airbag 106. In the example shown, two airbag deployment circuits 12 are connected to the energy source 14. Additional airbag deployment circuits 12 may be added and connected as indicated at 20.

Each airbag deployment circuit 12 includes a current regulator 22. At least one squib deployment circuit 24 is connected to the current regulator 22. In the example shown there are four squib deployment circuits 24 attached to the current regulator 22. The number of squib deployment circuits 24 attached to each current regulator 22 may vary. Squib deployment circuits 24 that are not deployed simultaneously are attached to the same current regulator 22. This is typically between two and four squib deployment circuits 24. In other words, all the squib deployment circuits 24 in an airbag deployment circuit 12 may not need to be deployed for a crash event. However, some squib deployment circuits 24 must be simultaneously deployed. Thus, the number of current regulators 22 in the electronic control unit 10 is equal to the number of squib deployment circuits 24 that must be deployed simultaneously.

Each of the squib deployment circuit 24 includes a high side transistor switch 26 and a low side transistor switch 28 and an airbag squib 32 (shown as a resistor). The high side transistor switch 26 and the low side transistor switch 28 controls the activation of the squib 32 that is located between them. Alternatively, the airbag deployment circuit 12 may include only high side transistor switches 26.

In a crash event the electronic control unit 10 sends a signal to the airbag deployment circuit 12. A current regulation switch 30 is located prior to each current regulator 22. Alternatively, the current regulation switch 30 can also be located before the current regulator 22. The current regulation switch 30 is closed if any of the squib deployment circuits 24 attached to the associated current regulator 22 need to be deployed. One or all of the current regulation switches 30 may be closed for any given crash event based upon the signals from the electronic control unit 10. Additionally, the high side transistor switch 26 and the low side transistor switch 28 are closed for each of the squib deployment circuits 24 that are to be deployed. In order to regulate the current to each squib deployment circuit 24, only one squib deployment circuit 24 may be deployed simultaneously per current regulator. Thus, with arrangement a shared current regulator can control current the multiple squib deployment circuits 24

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A circuit for an electronic control unit comprising:
an energy source;
a first current regulator connected to said energy source; and
a plurality of squib deployment circuits connected to said current regulator.

2. The circuit of claim 1, wherein each of said plurality of squib deployment circuits are connected to a corresponding plurality of high side transistor switches and a corresponding plurality of low side transistor switches.

3. The circuit of claim 1, wherein each of said plurality of squib deployment circuits are arranged to not have to deploy simultaneously.

4. The circuit of claim 1, wherein said plurality of squib deployment circuits comprises between two and four squib deployment circuits.

5. The circuit of claim 1, wherein said energy source is a vehicle battery.

6. The circuit of claim 1, wherein said energy source includes an energy reserve connected to said circuit with an energy reserve switch.

7. The circuit of claim 1, including a second current regulator connected in parallel to said first current regulator, and a second plurality of squib deployment circuits connected to said second current regulator.

8. The circuit of claim 7, wherein a current regulation switch is connected between said energy source and said first current regulator and a second current regulation switch is connected between said energy source and said second current regulator.

9. An electronic control unit for an airbag deployment system comprising:
an energy source; and
a plurality of current regulators each connected to said energy source with a current regulation switch, wherein said plurality of current regulators are each connected to a plurality squib deployment circuits.

10. The electronic control unit of claim 9, wherein said plurality of current regulators are connected in parallel to said energy source, and said plurality of squib deployment circuits are connected in parallel to said plurality of current regulators.

11. The electronic control unit of claim 9, wherein each of said plurality of squib deployment circuits are connected to a high side transistor switch and a low side transistor switch.

12. The electronic control unit of claim 9, wherein said plurality of squib deployment circuits associated with one of said plurality of current regulators are arranged to not have to deploy simultaneously.

13. The electronic control unit of claim 12, wherein said plurality of squib deployment circuits comprises between two and four squib deployment circuits.

14. The electronic control unit of claim 9, wherein said energy source is a vehicle battery.

15. The electronic control unit of claim 9, wherein said energy source includes an energy reserve connected to said plurality of squib deployment circuits with an energy reserve switch.

16. A method of controlling an electronic control unit for a restraint system comprising:
a) controlling current flow from an energy source to a first plurality of squib deployment circuits with a first current regulator; and
b) closing a first regulator switch to provide current to the first current regulator and the first plurality of squib deployment circuits.

17. The method of claim 16, wherein said step b) includes providing current to the first plurality of squib deployment circuits simultaneously.

18. The method of claim 16, wherein said step b) includes closing a high side transistor switch and a low side transistor switch for each of the first plurality of squib deployment circuits.

19. The method of claim 16, further comprising:
c) controlling current flow from the energy source to a second plurality of squib deployment circuits with a second current regulator; and
e) closing a second regulator switch to provide current to the second current regulator and the second plurality of squib deployment circuits.

20. The method of claim 19, wherein said step b) and said step e) include providing current to the first plurality of squib deployment circuits and the second plurality of squib deployment circuits simultaneously.
